(19) United States
(12) Patent Application Publication
(10) Pub. No.: US 2026/0267203 A1
(43) Pub. Date: Sep. 10, 2026

(54) IMAGE CAPTURING APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: DAISUKE ISHIKAWA, Kanagawa (JP)

(21) Appl. No.: 19/550,735

(22) Filed: Feb. 26, 2026

(30) Foreign Application Priority Data
Mar. 10, 2025 (JP) 2025-037300

(51) Int. Cl. G03B 13/36; G02B 7/28; H04N 23/69

(52) U.S. Cl. CPC G03B 13/36; G02B 7/28; H04N 23/69

(57) ABSTRACT

An image capturing apparatus capable of obtaining an effect that good focus is maintained during zooming even if thermal expansion of a lens barrel occurs due to a temperature rise. The image capturing apparatus includes an imaging optical system that includes a first lens movable in an optical axis direction, a first motor that moves the first lens, a position sensor that detects a position of the first lens, a memory device that stores instructions, and a processor that executes the instructions to control movement of the first lens by outputting a control signal to the first motor to move the first lens from a reference position to a target position, calculate a difference between the position of the first lens detected by the position sensor and the target position, and allow to change the reference position based on a shift amount of an image plane obtained from the difference.

### BACKGROUND

### Field of the Technology

The aspect of the embodiments relates to an image capturing apparatus, a control method therefor, and a storage medium storing a control program therefor.

### Description of the Related Art

A lens barrel that mechanically supports a plurality of lens groups in an image capturing apparatus is constituted by structural members such as mold members and metal members. When an ambient temperature of the image capturing apparatus or a temperature inside the image capturing apparatus varies, the structural members constituting the lens barrel may expand or contract due to mechanical thermal expansion or contraction thereof. Such expansion and contraction may change positional relationships between lenses. In this case, there is a problem that an in-focus state cannot be maintained during zooming, for example.

Japanese Patent Publication No. 3581513 and Japanese Patent Publication No. 4857257 disclose techniques to solve such a problem. For example, a positional deviation amount of a focus lens is obtained based on a change in temperature detected by a temperature sensor provided in the image capturing apparatus, and a focus lens position, a zoom lens position, and drive ranges thereof are corrected.

However, size of a lens barrel is increased as increasing a resolution accompanying upscaling images to 4K or heightening an image quality by upsizing an image sensor in recent years. On the other hand, a user is eager to miniaturize an image capturing apparatus. When the lens barrel is made compact, it is necessary to increase a sensitivity of a focus movement with respect to a lens movement.

On the other hand, when the sensitivity of the focus movement with respect to the lens movement is heightened, a focus deviation occurs due to movement of the lens group caused by expansion and contraction of the structural members of the lens unit due to thermal expansion and contraction. In particular, a mechanical mold member has a large variation in expansion and contraction due to change in temperature. Therefore, the positional relationships between the lens groups do not satisfy desired relationships. As a result, there is a problem that a focus deviation occurs during zooming, for example.

### SUMMARY

Accordingly, an aspect of the embodiments provides an image capturing apparatus including an imaging optical system configured to include a first lens movable in an optical axis direction, a first motor configured to move the first lens according to a control signal, a position sensor configured to detect a position of the first lens, a memory device that stores a set of instructions, and at least one processor that executes the set of instructions to control movement of the first lens by outputting the control signal to the first motor to move the first lens from a reference position to a target position, calculate a difference between the position of the first lens detected by the position sensor and the target position, and allow to change the reference position based on a shift amount of an image plane obtained from the difference.

Features of the present disclosure will become apparent from the following description of embodiments with reference to the attached drawings. The following description of embodiments is described by way of example.

### BRIEF DESCRIPTION OF THE DRAWINGS

FIG. 1 is a configuration diagram of an image capturing apparatus.

FIG. 2 is a flowchart illustrating an initialization process.

FIG. 3 is a graph illustrating a relationship between a counter value of a step counter and a counter value of a position counter as a two-dimensional coordinate.

FIG. 4 is a flowchart illustrating a difference calculation process.

FIGS. 5A and 5B are graphs illustrating changes in the relationship between the counter value of the step counter and the counter value of the position counter due to temperature change.

FIG. 6 is a flowchart illustrating a first correction process.

FIG. 7 is an explanatory diagram illustrating a positional relationship between a zoom lens and an auxiliary variable power lens.

FIG. 8 is an explanatory diagram of the first correction process.

FIG. 9 is a flowchart illustrating a second correction process.

FIG. 10 is an explanatory diagram of the second correction process.

FIG. 11 is a flowchart illustrating a process for switching between the first correction process and the second correction process.

### DESCRIPTION OF THE EMBODIMENTS

Hereinafter, embodiments of the present disclosure will be described in detail with reference to the attached drawings. However, the configurations described in the following embodiments are merely examples, and the scope of the present invention is not limited by the configurations described in the embodiments. Although a video camera is described as an example of the image capturing apparatus in the present embodiment, the present disclosure is also applicable to other image capturing apparatuses such as a digital still camera.

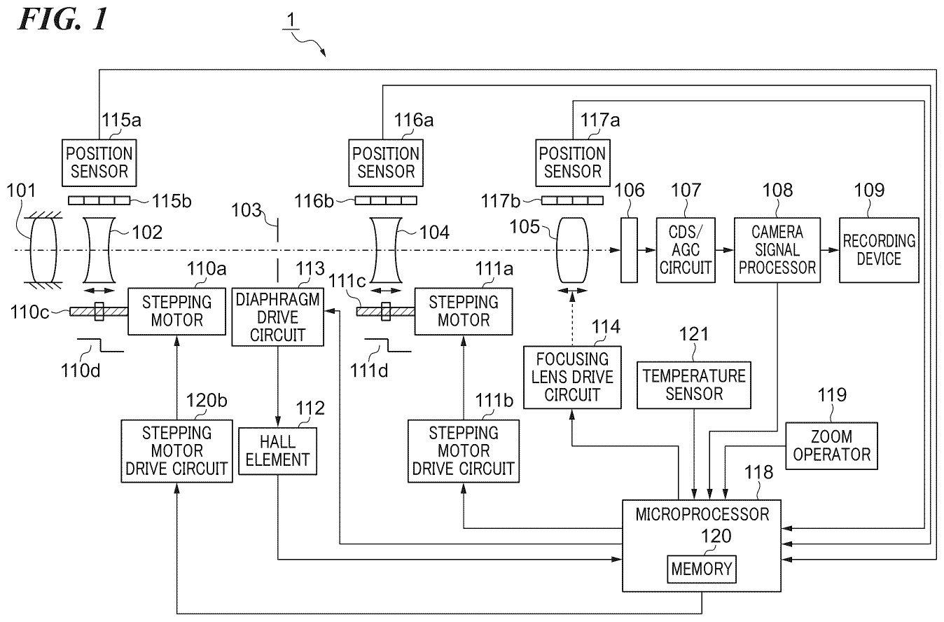

FIG. 1 is a configuration diagram of a video camera 1 according to the present embodiment. The video camera 1 (an image capturing apparatus) includes an optical system. The optical system includes a first fixed lens 101, a zoom lens 102 that moves in an optical axis direction to perform zooming, an auxiliary variable power lens 104 that moves in the optical axis direction according to a position of the zoom lens 102, and a focus lens (focus compensator lens) 105. The focus lens 105 is a lens having both a function of correcting movement of a focal plane associated with zooming and a focusing function. A diaphragm 103 is provided between the zoom lens 102 and the auxiliary variable power lens 104. The first fixed lens 101, the zoom lens 102, the diaphragm 103, the auxiliary variable power lens 104, and the focus lens 105 constitute an imaging optical system.

The video camera 1 includes an image sensor 106, a CDS/AGC circuit 107, and a camera signal processor 108. The image sensor 106 is fixed behind the focus lens 105. The image sensor 106 is a photoelectric conversion element, such as a CCD sensor, a CMOS sensor, or the like, and outputs an image signal corresponding to an object image formed by the imaging optical system. The CDS/AGC circuit 107 samples the output signal from the image sensor 106 and adjusts gain. The camera signal processor 108 converts the output signal of the CDS/AGC circuit 107 into a signal supported by a recording device 109, which will be described later.

The video camera 1 includes a microprocessor 118 (CPU). The microprocessor 118 (computer) has a memory 120 mounted therein. Connected to the microprocessor 118 are stepping motor drive circuits 120b and 111b, a diaphragm drive circuit 113, a Hall element 112, a focus lens drive circuit 114, a temperature sensor 121, the camera signal processor 108, and a zoom operator 119. Furthermore, three position sensors 115a, 116a, and 117a are connected to the microprocessor 118.

The stepping motor drive circuit 120b drives a stepping motor 110a, which is a drive source for driving the zoom lens 102. A lead screw shaft 110c is engaged with a rotating shaft of the stepping motor 110a. Therefore, when the stepping motor 110a is driven and its rotating shaft rotates, the lead screw shaft 110c rotates. As a result, the zoom lens 102 is driven in an optical axis direction (an arrow direction in FIG. 1) by an engaging action between the lead screw shaft 110c and a rack portion of a holding frame of the zoom lens 102.

At the time of startup of the image capturing apparatus, the zoom lens 102 is set to a position that serves as a reference in its position control (reference position). For this reason, the image capturing apparatus is provided with a reference position sensor 110d for detecting whether the zoom lens 102 is located at the reference position. Subsequently, when the zoom lens 102 will be moved to a target position, the stepping motor drive circuit 120b provides the stepping motor 110a with a drive signal of a number of pulses required to move the zoom lens 102 from the reference position to the target position to drive the stepping motor 110a.

The reference position sensor 110d is a photo-interrupter having a light-emitting element and a light-receiving element provided at a position facing the light-emitting element. When the zoom lens 102 is moved, a light-shielding member formed on a lens holding frame of the zoom lens 102 can enter between the light-emitting element and the light-receiving element of the photo-interrupter. When light traveling from the light-emitting element is received by the light-receiving element, the reference position sensor 110d outputs a High signal. When the light-shielding member shields light traveling from the light-emitting element toward the light-receiving element, the reference position sensor 110d outputs a Low signal. The position where the signal is just changed from High to Low is defined as the reference position of the zoom lens 102. This position is set as a reference position for a step counter Sz, which is described later, of the zoom lens 102 and the position sensor 115a. Note that the light-shielding member has a shape that enables zone detection as to whether the zoom lens 102 is on a telephoto side or a wide-angle side.

A position scale 115b for detecting a position of the zoom lens 102 is fixed to the holding frame of the zoom lens 102. Further, the position sensor 115a is fixed at a position facing the position scale 115b. A scale pattern, such as a magnetic pattern or a light reflection pattern, is formed on the position scale 115b in the optical axis direction. The position sensor 115a is configured to be able to detect the position of the zoom lens 102 in the optical axis direction by reading a magnetic signal, a light reflection signal, or the like of the scale pattern of the position scale 115b. A detection signal of the position sensor 115a is input to the microprocessor 118 and is used for position control of the zoom lens 102.

A diaphragm unit provided with the diaphragm 103 includes the diaphragm drive circuit 113 including a galvanometer actuator, diaphragm blades driven to open and close by the actuator, and the Hall element 112 that detects and outputs diaphragm opening state information indicating a diaphragm opening state. The Hall element 112 is a position detection element. The microprocessor 118 can appropriately control the state of the diaphragm 103 by obtaining the diaphragm opening state information detected by the Hall element 112 and driving an actuator of the diaphragm drive circuit 113.

The stepping motor drive circuit 111b drives a stepping motor 111a, which is a drive source for driving the auxiliary variable power lens 104. A lead screw shaft 111c is engaged with a rotating shaft of the stepping motor 111a. Therefore, when the stepping motor 111a is driven and its rotating shaft rotates, the lead screw shaft 111c rotates. As a result, the auxiliary variable power lens 104 is driven in the optical axis direction (the arrow direction in FIG. 1) by an engaging action between the lead screw shaft 111c and a rack portion of a holding frame of the auxiliary variable power lens 104.

At the time of startup of the image capturing apparatus, the auxiliary variable power lens 104 is set to a position that serves as a reference in terms of position control (reference position). For this reason, the image capturing apparatus has a reference position sensor 111d for detecting whether the auxiliary variable power lens 104 is located at the reference position. When the auxiliary variable power lens 104 will be driven to a target position, the stepping motor drive circuit 111b provides the stepping motor 111a with a drive signal of a number of pulses required to move the auxiliary variable power lens 104 from the reference position to the target position to drive the stepping motor 111a.

The reference position sensor 111d is a photo-interrupter having a light-emitting element and a light-receiving element provided at a position facing the light-emitting element. It is configured such that, in accordance with movement of the auxiliary variable power lens 104 to the reference position, a light-shielding member formed on a lens holding frame of the auxiliary variable power lens 104 enters between the light-emitting element and the light-receiving element. When the light-shielding member shields light traveling from the light-emitting element toward the light-receiving element, it is detected that the auxiliary variable power lens 104 is located at the reference position. This position is set as a reference position for a step counter of the auxiliary variable power lens 104, which will be described later, and the position sensor 115a. Note that the light-shielding member is formed in a shape that enables zone detection as to whether the auxiliary variable power lens 104 is on a telephoto side or a wide-angle side.

A position scale 116b for detecting the position of the auxiliary variable power lens 104 is fixed to a holding frame of the auxiliary variable power lens 104. Furthermore, the position sensor 116a is fixed at a position facing the position scale 116b. A scale pattern such as a magnetic pattern or an optical reflection pattern is formed on the position scale 116b in the optical axis direction. The position sensor 116a is configured to be able to detect the position of the auxiliary variable power lens 104 in the optical axis direction by reading the magnetic signal, optical reflection signal, or the like of the scale pattern of the position scale 116b. A detection signal from the position sensor 116a is input to the microprocessor 118 and is used for position control of the auxiliary variable power lens 104.

The focus lens drive circuit 114 drives the focus lens 105 to a target position. The position scale 117b for detecting the position of the focus lens 105 is fixed to a holding frame of the focus lens 105. The position sensor 117a is fixed at a position facing the position scale 117b. A scale pattern such as a magnetic pattern or an optical reflection pattern is formed on the position scale 117b in the optical axis direction.

The position sensor 117a is configured to be able to detect the position of the focus lens 105 in the optical axis direction by reading the magnetic signal, optical reflection signal, or the like of the scale pattern of the position scale 117b. Position information indicating the position detected by the position sensor 117a is input to the microprocessor 118, and the microprocessor 118 feeds back the position information to form a servo control system to position the focus lens 105 at a desired position.

In the present embodiment, it is assumed that the focus lens 105 is driven by a voice coil motor (VCM), but other types of actuators such as a DC motor or an ultrasonic motor may be used. Furthermore, a stepping motor can be used as a drive source for moving the focus lens 105. When the stepping motor is used as the drive source of the focus lens 105, a counter value of the number of pulses applied to the stepping motor is used as the position information, and the position sensor 117a and the position scale 117b may be omitted.

Furthermore, the stopping accuracy of the drive source of the focus lens 105 needs to be higher than the stopping accuracy of the drive sources of the zoom lens 102 and the auxiliary variable power lens 104. That is, the higher accuracy is required when correcting the positions of the zoom lens 102 and the auxiliary variable power lens 104. The stopping accuracy of the drive source of the focus lens 105 may be determined based on the position sensitivities of the zoom lens 102 and the auxiliary variable power lens 104, the depth of field of the imaging optical system provided in the image capturing apparatus, and the like.

The microprocessor 118 as a control unit controls the overall operation of the video camera 1. The microprocessor 118 controls the stepping motor drive circuits 120b and 111b, the diaphragm drive circuit 113, and the focus lens drive circuit 114. Furthermore, the microprocessor 118 receives signals output from the Hall element 112, the temperature sensor 121, the camera signal processor 108, the zoom operator 119, and the position sensors 115a, 116a, and 117a, and executes required processes.

When the microprocessor 118 provides the number of steps (number of pulses) as a control signal to the stepping motor drive circuits 120b and 111b, the stepping motors 110a and 111a are driven according to the provided number of steps. As a result, the zoom lens 102 and the auxiliary variable power lens 104 are moved. In addition, the microprocessor 118 controls the focus lens drive circuit 114 to move the focus lens 105.

The microprocessor 118 includes an A/D convertor. The microprocessor 118 digitizes an analog signal output from a temperature sensor 121, which indicates the temperature inside the lens barrel, using the A/D convertor to grasp the temperature inside the lens barrel. Furthermore, the microprocessor 118 receives a zoom value set by a user from the zoom operator 119 that allows the user to perform a setting operation of the zoom value. The microprocessor 118 provides a control signal (pulse signal) to the stepping motor drive circuit 120b so as to achieve the received zoom value. As a result, the stepping motor 110a is driven and the zoom lens 102 is moved so as to reach the zoom value set by the user.

An imaging signal from the image sensor 106 is gain-adjusted by the CDS/AGC circuit 107 and input to the camera signal processor 108. The camera signal processor 108 generates imaging signals for moving images and still images from the input signal and sends them to the recording device 109. The recording device 109 records the moving images and still images on a mounted recording medium. The recording device 109 allows the recording medium to be attachable and detachable. Examples of the recording medium include a magnetic tape, a semiconductor memory, a DVD (Digital Versatile Disk), and the like.

The memory 120 mounted on the microprocessor 118 stores position information on a telephoto side and a wide-angle side (a telephoto end, a wide-angle end) with respect to the reference position of the zoom lens 102. Furthermore, the memory 120 stores position sensitivities of the zoom lens 102, auxiliary variable power lens 104, and focus lens 105.

Furthermore, the memory 120 stores cam trajectory data. This cam trajectory data is trajectory data of each of the auxiliary variable power lens 104 and the focus lens 105 generally used in the video camera 1. The microprocessor 118 controls the stepping motor drive circuit 111b for the auxiliary variable power lens 104 and the focus lens drive circuit 114 by an electronic cam system using the cam trajectory data stored in the memory 120. Thereby, a magnification changing operation of the imaging optical system and a focusing operation associated therewith are performed. There is no particular limitation on the driving system of the stepping motor used in the present embodiment, and for example, a 1-2 phase driving system or a 2 -2 phase driving system may be used.

The microprocessor 118 performs feedback control of the actuator of the diaphragm drive circuit 113 such that an input luminance signal component always has an appropriate value. At this time, the microprocessor 118 converts an analog signal output from the Hall element 112 (position detection element), which indicates diaphragm opening state information, into a digital signal by the A/D convertor to grasp it as the opening state information of the diaphragm 103. Based on the opening state information, the microprocessor 118 controls the diaphragm 103 by giving an opening/closing control signal to the diaphragm drive circuit 113 such that the luminance signal component always has an appropriate value. The microprocessor 118 can also provide an opening/closing control signal to the diaphragm drive circuit 113 for bringing the opening state of the diaphragm 103 to a predetermined opening state.

Furthermore, a focus operator that allows the user to operate and set a focus value may be provided. The focus operator is an operation member for driving the focus lens 105. The focus value operated and set with the focus operator is sent to the microprocessor 118. In response thereto, the microprocessor 118 provides a drive signal to the focus lens drive circuit 114 based on the focus value. As a result, the focus lens 105 is moved so as to reach the focus value set by the user.

Here, a step counter Sz and a position counter Pz necessary for the following description will be briefly described. The rotating shaft of the stepping motor 110a is rotated according to the number of supplied pulses, and the corresponding zoom lens 102 is moved. The step counter counts this number of supplied pulses. The stepping motor drive circuit 120b may include the step counter and the microprocessor 118 reads and manages it, or the microprocessor 118 may include the step counter. When the microprocessor 118 provides a control signal of a predetermined number of pulses to the stepping motor drive circuit 120b, the stepping motor drive circuit 120b provides this to the stepping motor 110a. As a result, the zoom lens 102 is moved according to the control signal. A position difference between the positions before and after the movement of the zoom lens 102 corresponds to the provided control signal pulse signal. The step counter Sz counts such pulse signals. For example, if the counter value of the step counter at the position before the movement of the zoom lens 102 is S1, the counter value of the step counter at the position after the movement of the zoom lens 102 is S2, and the number of provided pulses is S3, a relationship of S1+S3=S2 is established. The step counter counts such counter values. Although the stepping motor 110a has been described here, the same is applicable to the other stepping motors 111a.

For example, the position sensor 115a of the zoom lens 102 may include the position counter and the microprocessor 118 may read a counter value of the position counter, or the microprocessor 118 may include the position counter. One counter value of the position counter corresponds to one counter value of the step counter. The counter value of the position counter at the position before movement of the zoom lens 102 shall be P1 and the counter value of the position counter at the position after the movement of the zoom lens 102 shall be P2. Then, if the number of pulses provided by the microprocessor 118 to the stepping motor drive circuit 120b (stepping motor 110a) is SG, a relationship of P1+SG=P2 is established. The position counter counts such counter values. Although the position sensor 115a has been described here, the same is applicable to the other position sensors 116a and 117a.

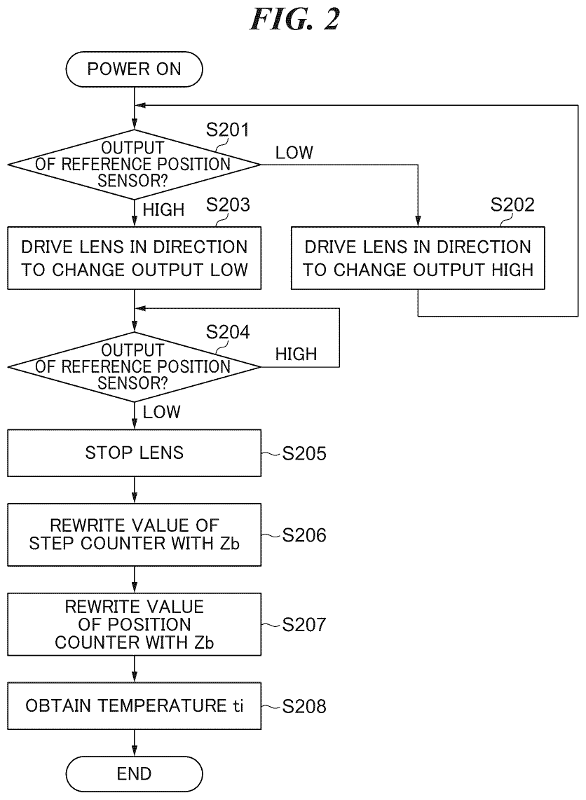

An initialization process of the stepping motor 110a, which is a drive source of the zoom lens 102, executed by the microprocessor 118 will be described with reference to FIG. 2. The initialization process shown in FIG. 2 is a process common to a stepping motor 110b that is a drive source of the auxiliary variable power lens 104.

First, when the power of the video camera 1 is turned ON, the microprocessor 118 determines whether the position of the zoom lens 102 is a position where the output of the reference position sensor 110d (photo-interrupter) is High in a step S201. That is, it is determined whether the position of the zoom lens 102 is its reference position.

In a step S201, when the microprocessor 118 determines that the output of the reference position sensor 110d is High, the process proceeds to a step S203. On the other hand, when it determines that the output of the reference position sensor 110d is Low, the process proceeds to a step S202. In the step S202, the microprocessor 118 executes drive control of the stepping motor 120a such that the output of the reference position sensor 110d becomes High, and repeats the determination in the step S201 again.

In the step S203, the microprocessor 118 drives and controls the stepping motor 110a to move the zoom lens 102 such that the output of the reference position sensor 110d becomes Low. Next, in a step S204, the microprocessor 118 continues the drive control of the stepping motor 110a until the output of the reference position sensor 110d is determined to be Low. That is, the microprocessor 118 repeats the determination in the step S204 while the output of the reference position sensor 110d is High, and when the output of the reference position sensor 110d becomes Low, the process proceeds to a step S205.

In the step S205, the microprocessor 118 stops the drive control of the stepping motor 110a to stop the movement of the zoom lens 102. As a result, the zoom lens 102 is set to the reference position. Next, in a step S206, the microprocessor 118 rewrites the counter value of the step counter Sz, which is a control signal for the stepping motor drive circuit 120b, to Zb. That is, the microprocessor 118 grasps an initial counter value of the stepping motor 110a by setting the counter value of the step counter Sz at the time of stopping the zoom lens 102 in the step S205 as Zb.

Next, in a step S207, the microprocessor 118 rewrites the counter value of the position counter Pz of the position sensor 115a to Zb. That is, the microprocessor 118 grasps an initial counter value of the position sensor 115a by setting the counter value of the position counter Pz at the time of stopping the zoom lens 102 in the step S205 as Zb. Then, in a step S208, the microprocessor 118 obtains an initialization temperature “ti” from the temperature sensor 121. Thus, the initialization process is completed. A similar initialization process is executed for the auxiliary variable power lens 104.

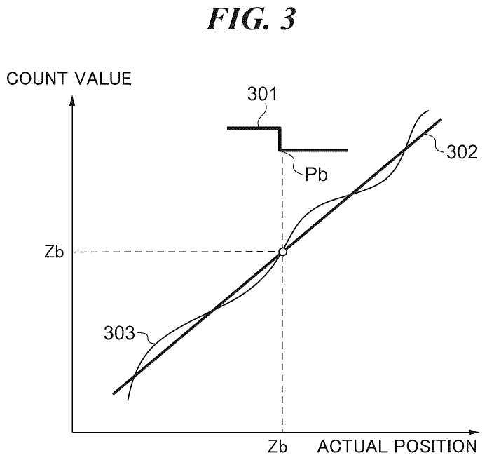

FIG. 3 is a graph showing the relationship between the counter value of the step counter Sz and the counter value of the position counter Pz in a two-dimensional coordinate. The horizontal axis in FIG. 3 represents the actual position of the zoom lens 102, and the vertical axis represents the counter values of the scan counter Sz and the position counter Pz. A thick straight line indicates a trajectory 302 of the step counter Sz, and a thin curve indicates a trajectory 303 of the position counter Pz.

As can be seen with reference to FIG. 3, at the end of the initialization process when the power is turned ON, both the counter value of the step counter Sz and the counter value of the position counter Pz are Zb. This counter value Zb indicates a position Pb (reference position) where an output 301 of the reference position sensor 110d switches from High to Low. Note that the trajectory 302 of the step counter Sz and the trajectory 303 of the position counter Pz do not completely coincide with each other except five positions including the position Pb. This is due to the influence of accumulated errors of the stepping motor 110a, the lead screw, and the like.

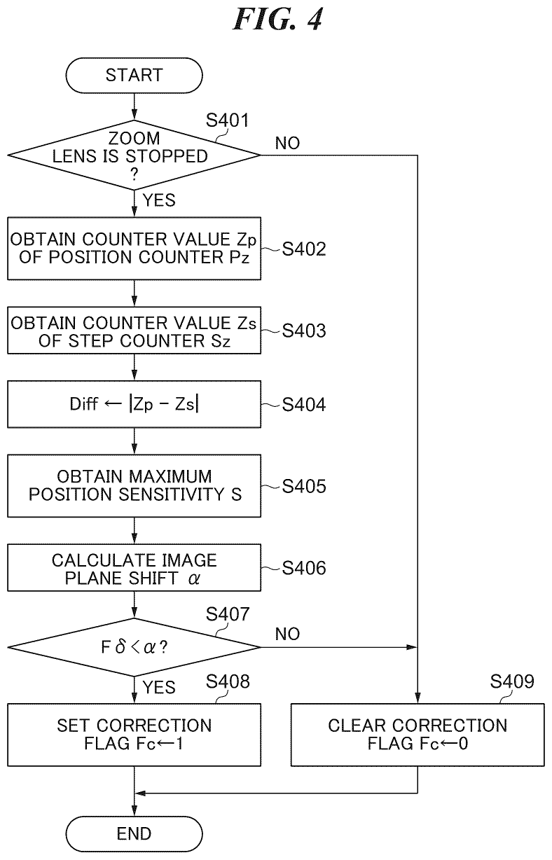

Next, a difference calculation process and a correction flag set/clear process will be described with reference to FIG. 4. FIG. 4 is a flowchart showing a process for obtaining a difference between the step counter Sz and the position counter Pz. Here, the difference calculation process will be described targeting the zoom lens 102. First, in a step S401, the microprocessor 118 determines whether the zoom lens 102 is stopped. When the microprocessor 118 determines that the zoom lens 102 is stopped (Yes), the process proceeds to a step S402. On the other hand, when it determines that it is not stopped (No), the process proceeds to a step S409.

Next, in the step S402, the microprocessor 118 obtains a counter value Zp of the position counter Pz for the zoom lens 102. Next, in a step S403, the microprocessor 118 obtains a counter value Zs of the step counter Sz for the zoom lens 102.

Next, in a step S404, the microprocessor 118 calculates a difference Diff between the counter value Zp of the position counter Pz obtained in the step S402 and the counter value Zs of the step counter Sz obtained in the step S403 using the following formula.

$$Diff = \vert Z p - Z s \vert \qquad ( Formula 1 )$$

Next, in a step S405, the microprocessor 118 obtains the maximum position sensitivity Smax. The maximum position sensitivity Smax is a ratio between a moving amount of a target lens and a shift amount of an image plane (amount of change in back focus) due to movement of the target lens. That is, the maximum position sensitivity Smax is the ratio of the shift amount of the image plane to the moving amount of the target lens.

Next, in a step S406, the microprocessor 118 calculates an absolute value α of the image plane shift from the difference Diff calculated in the step S404 and the maximum position sensitivity Smax using the following formula 2. The absolute value α of the image plane shift indicates the maximum shift amount on an image sensor on which an object image is formed, corresponding to the shift amount of the lens.

$$α = \vert Diff \times S max \vert \qquad ( Formula 2 )$$

In a step S407, the microprocessor 118 determines whether the absolute value α of the image plane shift is more than a focal depth Fδ. If the microprocessor 118 determines that it is more (Yes), the process proceeds to a step S408. On the other hand, when it determines otherwise (No), the process proceeds to the step S409.

Next, in the step S408, the microprocessor 118 sets a correction flag Fc to “1”. On the other hand, in the step S409, the microprocessor 118 clears the correction flag Fc to “0”. Through the above process, the difference Diff is obtained and the correction flag Fc is set or cleared.

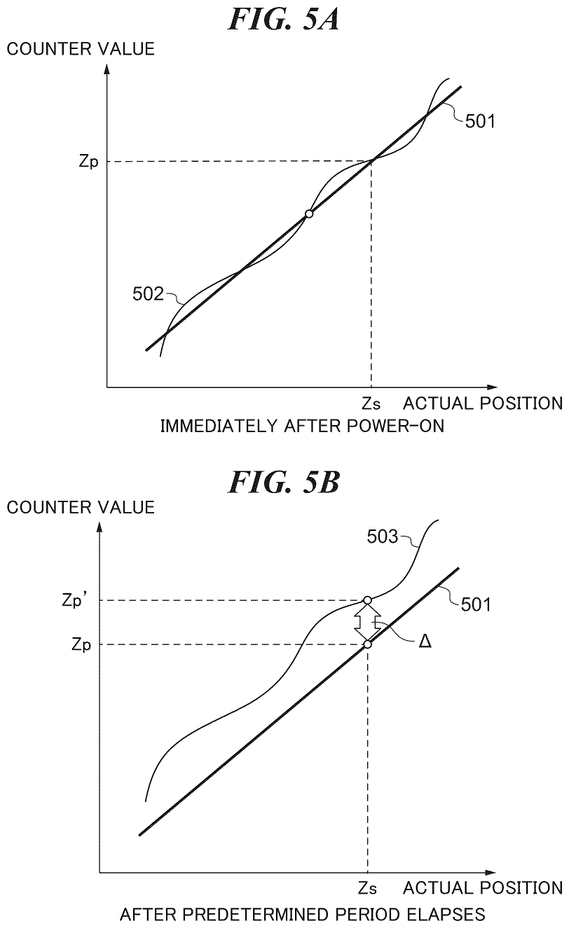

The process in FIG. 4 will be further described with reference to FIGS. 5A and 5B. In each of FIGS. 5A and 5B, the horizontal axis represents the step counter Sz and the vertical axis represents the position counter Pz.

FIG. 5A shows a trajectory 501 of the step counter Sz and a trajectory 502 of the position counter Pz immediately after the power is turned ON. Immediately after the power is turned ON, the temperature inside the video camera 1 has not risen, and expansion/contraction of the lens barrel member or the like has not occurred. In this state, for example, it is assumed that the counter value Zp of the position counter Pz and the counter value Zs of the step counter Sz obtained in the steps S402 and S403 are substantially equal.

FIG. 5B shows a trajectory 503 of the position counter Pz at a timing when a predetermined period has elapsed since the power was turned ON. As shown in FIG. 5B, after the predetermined period has elapsed since the power was turned ON, expansion/contraction of the lens barrel member or the like occurs due to a temperature rise inside the video camera 1. Due to this influence, a shift Δ occurs between the counter value of the position counter Pz and the counter value of the step counter Sz. The counter value of the position counter Pz, which was Zp immediately after the power was turned ON, becomes Zp′ after the predetermined period has elapsed.

The aforementioned difference Diff is a calculated value indicating the degree of divergence between the position counter Pz and the step counter Sz. If this value is large, the relationship between the position counter Pz and the step counter Sz will not be in a desired state, leading to focus deviation during zooming.

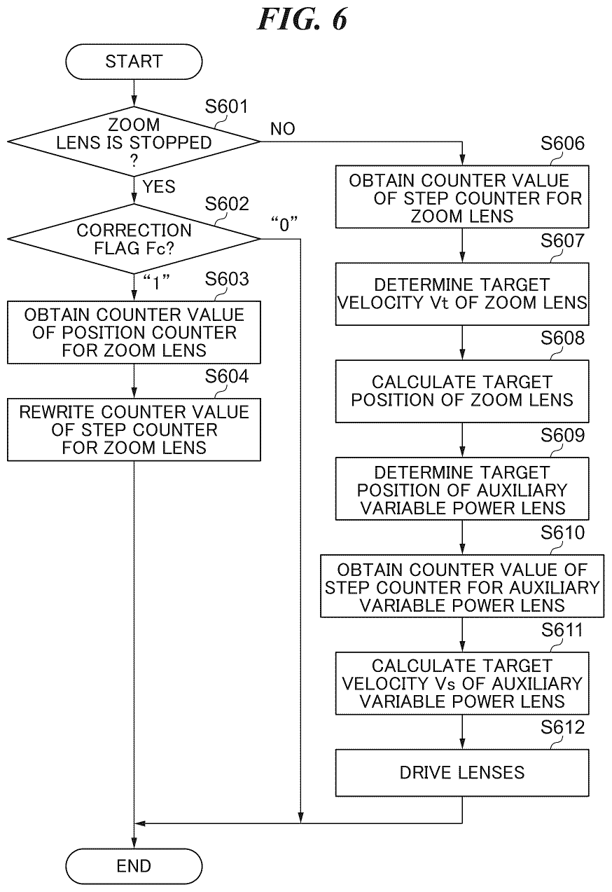

Next, a method for correcting the counter value of the step counter Sz using the counter value of the position counter Pz will be described. In this method, generation of a target position of the auxiliary variable power lens 104 that moves in conjunction with the zoom lens 102 will also be described simultaneously. There are two correction methods. A first correction method will be described with reference to FIG. 6. Note that the process shown in FIG. 6 is repeatedly executed every predetermined control period T. FIG. 6 is a flowchart showing the first correction process.

First, in a step S601, the microprocessor 118 determines whether the zoom lens 102 is stopped. If the microprocessor 118 determines that the zoom lens 102 is stopped (Yes), the process proceeds to a step S602. On the other hand, if it determines otherwise (No), the process proceeds to a step S606.

In the step S602, the microprocessor 118 checks the correction flag Fc generated in the process in FIG. 3. If the value of the correction flag Fc is “1”, the microprocessor 118 proceeds with the process to a step S603. On the other hand, if the value of Fc is “0”, the microprocessor 118 ends the process shown in FIG. 6 because there is no need for the correction process.

In the step S603, the microprocessor 118 obtains a counter value Zs′ of the position counter Pz for the zoom lens 102. Next, in a step S604, the microprocessor 118 rewrites the counter value of the step counter Sz for the zoom lens 102 with the counter value Zs′ of the position counter Pz. This process corresponds to shifting the output position of the reference position sensor 110d, which outputs the reference position, by the difference Diff. That is, the microprocessor 118 changes the reference position of the control based on the difference Diff.

When the microprocessor 118 determines in the step S601 that the zoom lens 102 is not being stopped (No), the process proceeds to the step S606. In the step S606, the microprocessor 118 obtains the current counter value of the step counter Sz for the zoom lens 102. Next, in a step S607, the microprocessor 118 determines a target velocity Vt for the zoom lens 102 by referring to a velocity table. That is, the microprocessor 118 determines the target velocity Vt based on the operation amount set by the user using the zoom operator 119 and the velocity table stored in the memory 120. In the velocity table, operation amounts of the zoom operator 119 and target velocities of the zoom lens 102 are registered in association with each other. The velocity table is non-volatilely stored in the memory 120 in advance, such as during product manufacturing.

In a step S608, the microprocessor 118 calculates a target position Szt of the zoom lens 102 based on the following formula using the target velocity Vt and the control period T.

$$Szt = V t \times T \qquad ( Formula 3 )$$

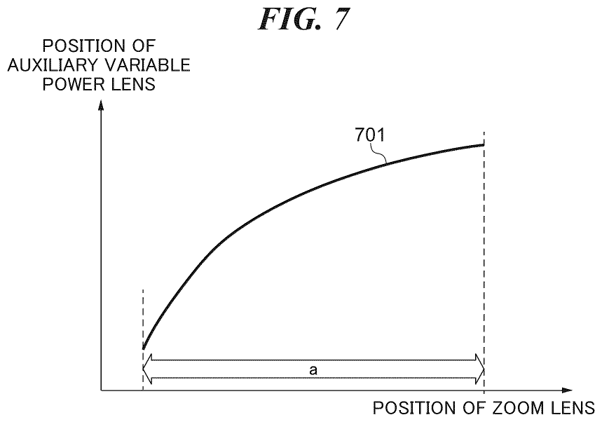

Next, in a step S609, the microprocessor 118 determines a target drive position Sst of the auxiliary variable power lens 104 corresponding to the target position Szt of the zoom lens 102 by referring to the table data in FIG. 7. FIG. 7 is a diagram showing the positional relationship between the zoom lens and the auxiliary variable power lens. A curve 701 showing the positional relationship between the two as shown in FIG. 7 is tabulated and non-volatilely stored in the memory 120.

Next, in step S610, the microprocessor 118 acquires a counter value Ss of the step counter Ps for the auxiliary variable power lens 104. Next, in step S611, the microprocessor 118 calculates a target velocity Vs of the auxiliary variable power lens based on the following formula using the target drive position Sst of the auxiliary variable power lens and the control period T:

$$Vs = ( S s t - S s ) / T \qquad ( Formula 4 )$$

Then, in a step S612, the microprocessor 118 controls the stepping motor drive circuit 120b to move the zoom lens 102 to the target position Zst at the target velocity Vt. At the same time, the microprocessor 118 controls the stepping motor drive circuit 111b to move the auxiliary variable power lens 104 to the target drive position Sst at the target velocity Vs.

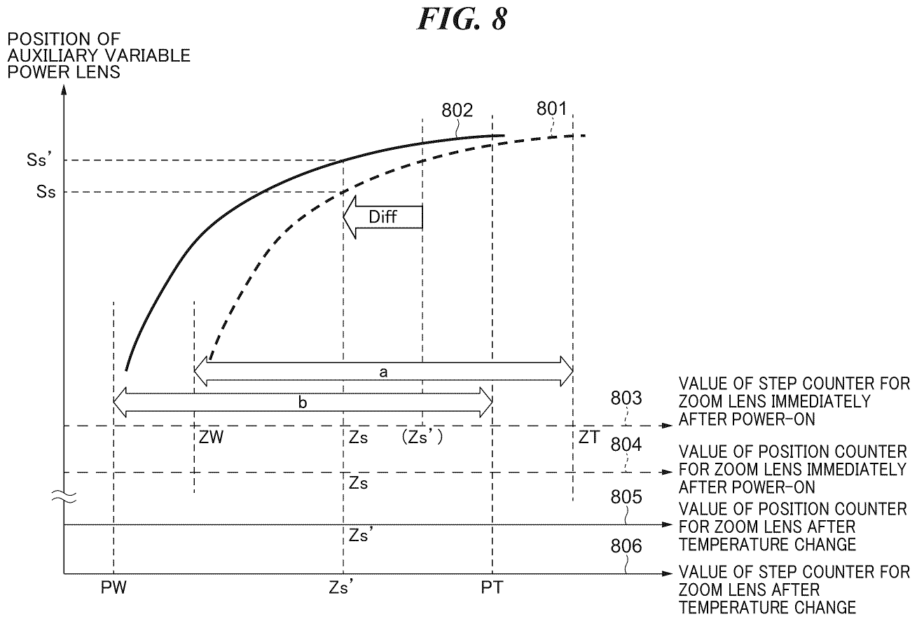

The details of the first correction process in FIG. 6 will be described with reference to FIG. 8. FIG. 8 shows a positional relationship 801 between the zoom lens 102 and the auxiliary variable power lens 104 immediately after the power is turned ON. Further, ZW and ZT indicate control ends, and the zoom lens 102 can move within the range indicated by a thick horizontal double-headed arrow “a”. The counter value of the step counter Sz of the zoom lens 102 at this time is indicated by a coordinate axis 803, and the counter value of the position counter Pz is indicated by a coordinate axis 804. The counter value of the position counter Pz corresponding to the counter value Zs of the step counter Sz of the zoom lens 102 is Zs, and both counter values are the same Zs (see the coordinate axes 803 and 804).

Further, FIG. 8 shows a positional relationship 802 between the zoom lens 102 and the auxiliary variable power lens 104 that has changed due to expansion/contraction of the lens barrel member caused by temperature change after a predetermined period has elapsed since the power was turned ON. The control ends at this time are indicated by PW and PT. The counter value of the position counter Pz of the zoom lens 102 at this time is indicated by a coordinate axis 805. The counter value of the position counter Pz with respect to Zs indicated by the step counter Sz of the zoom lens 102 at this time is Zs′, which is a counter value different from that immediately after the power was turned on (Zs≠Zs′).

In S603 and S604 in FIG. 6, the process of rewriting the counter value of the step counter Sz of the zoom lens 102 to Zs′ is performed. When expansion/contraction of the lens barrel member occurs due to temperature changes over time from immediately after the power is turned ON by this process, the counter value of the step counter Sz of the zoom lens 102 is indicated by a coordinate axis 806. As a result, the moving range of the zoom lens 102 changes from the range indicated by “a” in FIG. 8 to the range indicated by “b”. As a result, the positional relationship 802 between the zoom lens 102 and the auxiliary variable power lens 104 becomes as shown in FIG. 8. The positional relationship 801 shifts by Diff (see Formula 1 in FIG. 8) due to temperature change to become the positional relationship 802.

By executing the process in FIG. 6 as described above, the positional relationship between the zoom lens 102 and the auxiliary variable power lens 104 is appropriately corrected by changing the driving range of the zoom lens 102, so that focus displacement does not occur during zooming and good performance can be maintained.

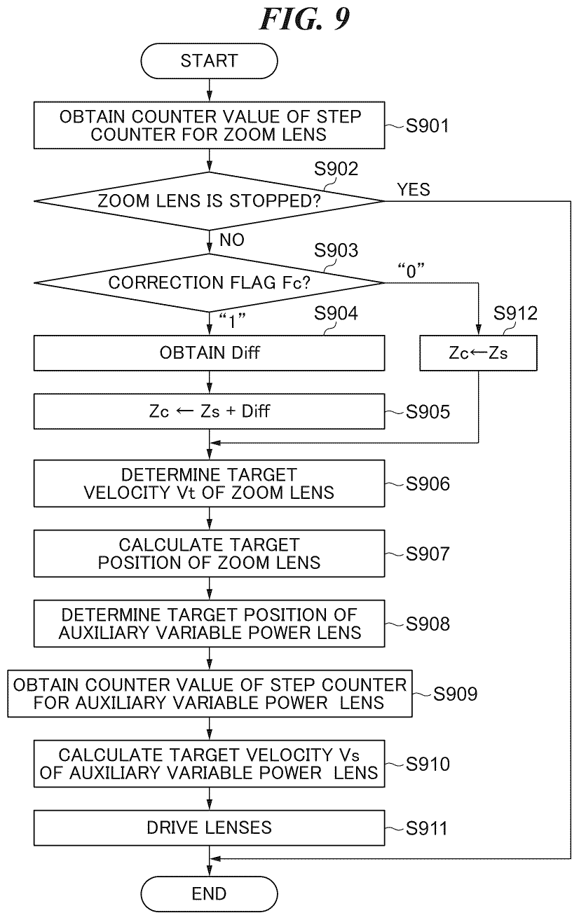

Next, a second correction method will be described with reference to FIG. 9. FIG. 9 is a flowchart showing the second correction process. First, in a step S901, the microprocessor 118 obtains the current counter value Zs indicated by the step counter Sz for the zoom lens 102. Next, in a step S902, the microprocessor 118 determines whether the zoom lens 102 is stopped. When the microprocessor 118 determines that the zoom lens 102 is stopped (Yes), the process ends. That is, when it is determined that the zoom lens 102 is stopped, the correction process is not performed. On the other hand, when it determines otherwise (No), the process proceeds to a step S903.

Next, in the step S903, the microprocessor 118 determines whether the correction flag Fc is “1” or “0”. When the microprocessor 118 determines that the correction flag Fc is “1”, the process proceeds to a step S904. On the other hand, when it determines that the correction flag Fc is “0”, the process proceeds to a step S912.

Next, in the step S904, the microprocessor 118 obtains the difference Diff (see Formula 1) calculated in the process in FIG. 4. Next, in a step S905, the microprocessor 118 obtains a corrected zoom position Zc of the zoom lens 102 in order to refer to the position of the auxiliary variable power lens 104 corresponding to the position of the zoom lens 102. The corrected zoom position Zc can be calculated by the following formula using the current counter value Zs of the step counter Sz and the absolute value of the difference Diff (see Formula 1).

$$Zc = Zs + Diff \qquad ( Formula 5 )$$

On the other hand, in the step S912, the microprocessor 118 substitutes the current counter value Zs of the step counter Sz for the corrected zoom position Zc.

$$Zc = Z s \qquad ( Formula 6 )$$

Next, in a step S906, the microprocessor 118 determines a target velocity Vt for the zoom lens 102 by referring to the velocity table. That is, the microprocessor 118 determines the target velocity Vt based on the operation amount set by the user using the zoom operator 119 and the velocity table stored in the memory 120. In the velocity table, operation amounts of the zoom operator 119 and target velocities of the zoom lens 102 are registered in association with each other.

Next, in a step S907, the microprocessor 118 calculates the target position Szt of the zoom lens 102 based on the following formula using the target velocity Vt and the control period T.

$$Szt = V t \times T \qquad ( Formula 7 )$$

Next, in a step S908, the microprocessor 118 determines the target drive position Sst of the auxiliary variable power lens 104 corresponding to the target position Szt of the zoom lens 102 based on data obtained by tabulating the curve 701 shown in FIG. 7, which represents the positional relationship between the zoom lens 102 and the auxiliary variable power lens 104.

Next, in a step S909, the microprocessor 118 obtains a value Ss of the step counter Ps for the auxiliary variable power lens 104. Next, in a step S910, the microprocessor 118 calculates the target velocity Vs of the auxiliary variable power lens 104 by the following formula using the target position Sst of the auxiliary variable power lens 104 and the control period T.

$$Vs = ( S s t - S s ) / T \qquad ( Formula 8 )$$

Then, in a step S912, the microprocessor 118 controls the stepping motor drive circuit 120b to move the zoom lens 102 to the target position Zst at the target velocity Vt. At the same time, the microprocessor 118 controls the stepping motor drive circuit 111b to move the auxiliary variable power lens 104 to the target position Sst at the target velocity Vs.

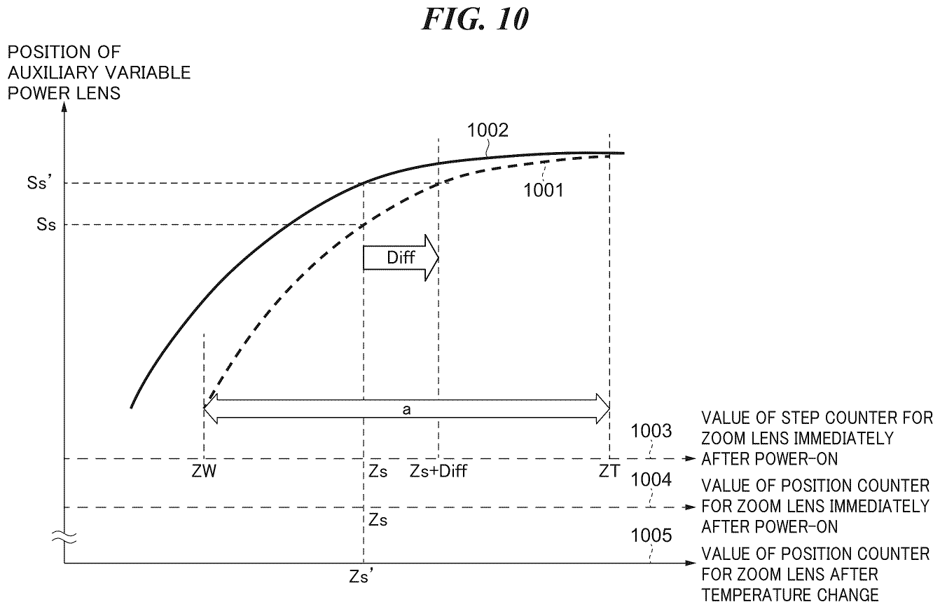

The details of the second correction process in FIG. 9 will be described with reference to FIG. 10. FIG. 10 shows a positional relationship 1001 between the zoom lens 102 and the auxiliary variable power lens 104 immediately after the power is turned ON. The positional relationship 1001 is rewritably and non-volatilely stored in the memory 120. Further, ZW and ZT indicate control ends, and the zoom lens 102 can move within a range indicated by the thick horizontal double-headed arrow “a”. The counter value of the step counter Sz of the zoom lens 102 at this time is indicated by a coordinate axis 1003, and the counter value of the position counter Pz is indicated by a coordinate axis 1004. The counter value of the position counter Pz corresponding to the counter value Zs of the step counter Sz of the zoom lens 102 is Zs, which is the same.

On the other hand, FIG. 10 shows a positional relationship 1002 between the zoom lens 102 and the auxiliary variable power lens 104 that has changed due to expansion/contraction of the lens barrel members caused by temperature change over time since the power was turned ON. The counter value of the position counter Pz of the zoom lens 102 at this time is indicated by a coordinate axis 1005. The counter value of the position counter Pz with respect to the counter value Zs indicated by the step counter Sz of the zoom lens 102 at this time is Zs′, which is different from that immediately after the power is turned on (Zs≠Zs′).

The position of the auxiliary variable power lens 104 corresponding to the position Zs of the zoom lens 102 is Ss based on the positional relationship 1001 immediately after the power is turned ON. On the other hand, when temperature change occurs after time has elapsed since the power was turned ON, the position of the auxiliary variable power lens 104 corresponding to the position Zs of the zoom lens 102 becomes Ss′ based on the positional relationship 1002.

This is because the positional relationship 1001 shifts along the horizontal axis by the difference Diff (=Zs−Zs′). At this time, the position Ss′ of the auxiliary variable power lens 104 corresponding to the corrected zoom position Zc (=Zs+Diff) obtained by shifting the position Zs of the zoom lens 102 by Diff can be obtained using the positional relationship 1001. This is achieved by the microprocessor 118 executing the process in the steps S603 and S604.

By executing the process in FIG. 9 as described above, the positional relationship between the zoom lens 102 and the auxiliary variable power lens 104 can be appropriately corrected without changing the driving range of the zoom lens 102, and good performance without focus displacement during zooming can be maintained.

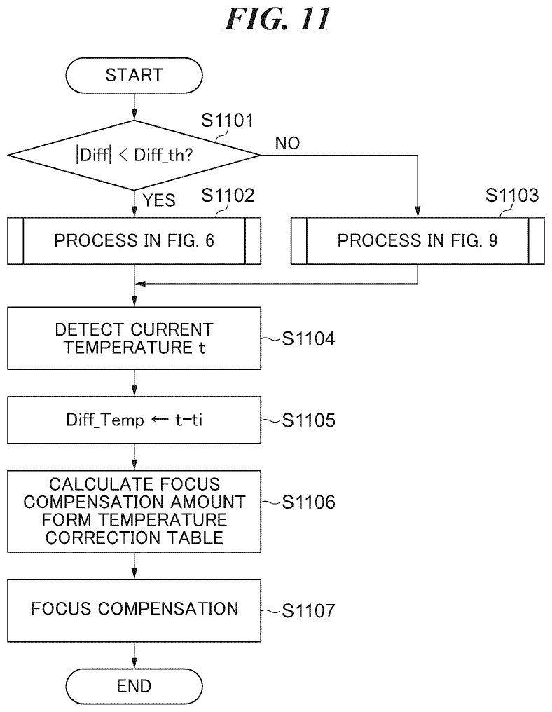

Next, a process for switching between the two modes of correction processes, the first correction process shown in FIG. 6 and the second correction process shown in FIG. 9, will be described with reference to FIG. 11. FIG. 11 is a flowchart showing a process for switching between the first correction process and the second correction process.

First, in a step S1101, the microprocessor 118 determines whether the absolute value of the difference Diff shown in FIG. 4 is less than a predetermined value Diff_th. When the microprocessor 118 determines that it is less (Yes), the process proceeds to a step S1102, while when it determines that it is not less (No), the process proceeds to a step S1103. In the step S1102, the microprocessor 118 executes the first correction process shown in FIG. 6. Further, in the step S1103, the microprocessor 118 executes the second correction process shown in FIG. 9.

Next, in a step S1104, the microprocessor 118 obtains the temperature detection result of the temperature sensor 121 to grasp the current temperature “t” in the lens barrel. Next, in a step S1105, the microprocessor 118 calculates a temperature difference Diff_Temp, which is a temperature difference between the reference temperature “ti” obtained during the initialization process in FIG. 2 and the current temperature “t”, using the following formula.

$$Diff\_Temp = t - t i \qquad ( Formula 9 )$$

Next, in a step S1106, the microprocessor 118 refers to a temperature correction table non-volatilely stored in the memory 120 in advance based on the Diff_Temp calculated in step S1105 to obtain a focus compensation amount. In the temperature correction table, for example, temperatures, lens types, and correction amounts are registered in association with each other. In this table, for example, each of a plurality of temperatures for each lens type and its correction amounts, and the like are registered.

Then, in a step S1107, a process for correcting the focus position is executed. For example, the microprocessor 118 controls the stepping motor drive circuit 120b to move the zoom lens 102 to the target position at the target velocity. At the same time, the microprocessor 118 controls the stepping motor drive circuit 111b to move the auxiliary variable power lens 104 to the target position at the target velocity.

When the absolute value of the difference Diff becomes less than the predetermined value (Diff_th) by the process in the step S1103, the correction process for shifting the drive range of the zoom lens 102 is executed in the step S1102. In this case, it is advantageous in terms of the accuracy of the angle of view by the zoom operation, and is an effective correction process when there is a sufficient margin to the mechanical end.

On the other hand, when the absolute value of the difference Diff is equal to or more than the predetermined value Diff_th, that is, when there is not a sufficient margin to move the lens to the mechanical end, the correction process can be executed without changing the drive range of the zoom lens 102. Therefore, the correction process can be executed by changing the position of the auxiliary variable power lens 104 corresponding to the position of the zoom lens 102. Furthermore, it is possible to avoid the zoom lens 102 from colliding with the mechanical end. From the above, the microprocessor 118 can be configured to switch between the first correction process and the second correction process based on the difference.

Further, through the processes from the steps S1104 to S1107 in FIG. 11, the microprocessor 118 can refer to the temperature correction table and perform, for example, the correction process for focus displacement due to temperature change of the first fixed lens 101 not equipped with a position sensor. By executing such temperature correction after the correction process in the step S1102 or S1103 described above, even more highly accurate temperature correction can be achieved. That is, the microprocessor 118 performs the focus compensation of the imaging optical system based on the temperature detected by the temperature sensor 121 or the like. This focus compensation is executed by the first correction process or the second correction process.

As described above, the image capturing apparatus according to the present embodiment includes an imaging optical system having a plurality of lenses including a first lens (102) movable in the optical axis direction, and a motor (110a) can move the first lens according to a supplied control signal. A drive control unit (118) supplies a control signal to the motor, and controls movement of the first lens from a reference position to a control position where the position amount corresponding to the supplied control signal is changed. Then, a position detection unit (115a) detects a lens position of the first lens, and a difference calculation unit (see Formula 1) calculates a difference between the detected lens position and the control position, and in the first correction process (S603, S604), the reference position is changed based on this difference. As one mode of the first correction process, shifting the reference position by an amount corresponding to the difference in the moving direction of the first lens can be cited.

A storage device stores positional relationship information (1001) in which lens positions of the first lens and lens positions of a second lens (104) different from the first lens are associated with each other, and the horizontal axis of the stored positional relationship information indicates the lens position of the first lens and the vertical axis indicates the position of the second lens. A second motor (111a) moves the second lens according to a supplied control signal. A second drive control unit (111b) supplies a control signal to the second motor based on the positional relationship information to control movement of the second lens to a lens position corresponding to a lens position of the first lens. Then, in a second correction process (S905), the positional relationship information is changed based on this difference. As one mode of the second correction process, shifting the stored positional relationship information along the horizontal axis by an amount corresponding to the difference can be cited.

According to the present embodiment, even if thermal expansion of the lens barrel or the like occurs due to a temperature rise in the image capturing apparatus, an effect that good focus can be maintained even during zooming or the like by performing correction of the lens position is obtained.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-037300, filed Mar. 10, 2025 which is hereby incorporated by reference herein in its entirety.

What is claimed is:

1. An image capturing apparatus comprising:
an imaging optical system configured to include a first lens movable in an optical axis direction;
a first motor configured to move the first lens according to a control signal;
a position sensor configured to detect a position of the first lens;
a memory device that stores a set of instructions; and
at least one processor that executes the set of instructions to:
control movement of the first lens by outputting the control signal to the first motor to move the first lens from a reference position to a target position;
calculate a difference between the position of the first lens detected by the position sensor and the target position; and
allow to change the reference position based on a shift amount of an image plane obtained from the difference.

2. The image capturing apparatus according to claim 1, wherein the at least one processor executes instructions in the memory device to determine whether to change the reference position based on the shift amount of the image plane.

3. The image capturing apparatus according to claim 2, wherein the at least one processor executes instructions in the memory device not to change the reference position in a case where an absolute value of the shift amount of the image plane is not more than a predetermined value and to change the reference position in a case where the absolute value of the shift amount of the image plane is more than the predetermined value.

4. The image capturing apparatus according to claim 3, wherein the predetermined value is a focal depth.

5. The image capturing apparatus according to claim 4, wherein the at least one processor executes instructions in the memory device to change the reference position in a case where the shift amount of the image plane is more than the focal depth.

6. The image capturing apparatus according to claim 1, wherein the at least one processor executes instructions in the memory device to obtain the shift amount of the image plane based on the difference and a maximum position sensitivity that is ratio of the shift amount of the image plane due to movement of the first lens to a moving amount of the first lens.

7. The image capturing apparatus according to claim 2, wherein the at least one processor executes instructions in the memory device to change the reference position based on the difference in a case of determining to change the reference position.

8. The image capturing apparatus according to claim 1, wherein the at least one processor executes instructions in the memory device to shift the reference position by an amount corresponding to the difference in a moving direction of the first lens.

9. The image capturing apparatus according to claim 1, further comprising:
a second motor configured to move a second lens different from the first lens according to a control signal, and
wherein the at least one processor executes instructions in the memory device to:
store positional relationship information in which lens positions of the first lens and lens positions of a second lens are associated with each other;
supply a control signal to the second motor based on the positional relationship information to control movement of the second lens to a lens position corresponding to a lens position of the first lens; and
change the positional relationship information based on the difference.

10. The image capturing apparatus according to claim 9, wherein a horizontal axis of the stored positional relationship information indicates the lens position of the first lens and a vertical axis indicates the position of the second lens, and
wherein the at least one processor executes instructions in the memory device to shift the stored positional relationship information along the horizontal axis by an amount corresponding to the difference.

11. The image capturing apparatus according to claim 9, wherein the at least one processor executes instructions in the memory device to switch between the change of the reference position and the change of the positional relationship information.

12. The image capturing apparatus according to claim 11, wherein the at least one processor executes instructions in the memory device to switch between the change of the reference position and the change of the positional relationship information based on the difference.

13. The image capturing apparatus according to claim 1, wherein the at least one processor executes instructions in the memory device to change the reference position in a case of determining that the first lens is stopped.

14. The image capturing apparatus according to claim 9, wherein the at least one processor executes instructions in the memory device not to change the positional relationship information in a case of determining that the first lens is stopped.

15. The image capturing apparatus according to claim 9, further comprising:
a temperature sensor configured to detect a temperature of the imaging optical system, and
wherein the at least one processor executes instructions in the memory device to perform focus compensation of the imaging optical system based on a temperature detected with the temperature sensor after changing the reference position or the positional relationship information.

16. The image capturing apparatus according to claim 1, wherein the first motor is a stepping motor and the target position is represented by a counter value of a step counter used to control the stepping motor.

17. The image capturing apparatus according to claim 16, wherein the at least one processor executes instructions in the memory device to change the reference position by rewriting a counter value of the step counter.

18. A control method for an image capturing apparatus providing an imaging optical system that includes a first lens movable in an optical axis direction, the control method comprising:
controlling movement of the first lens by outputting a control signal to a first motor, which is capable of moving the first lens according to the control signal, to move the first lens from a reference position to a target position;
detecting a position of the first lens with a position sensor;
calculating a difference between the position of the first lens detected by the position sensor and the target position; and
allowing to change the reference position based on a shift amount of an image plane obtained from the difference.

19. A non-transitory computer-readable storage medium storing a control program causing a computer to execute a control method for an image capturing apparatus providing an imaging optical system that includes a first lens movable in an optical axis direction, the control method comprising:
controlling movement of the first lens by outputting a control signal to a first motor, which is capable of moving the first lens according to the control signal, to move the first lens from a reference position to a target position;
detecting a position of the first lens with a position sensor;
calculating a difference between the position of the first lens detected by the position sensor and the target position; and
allowing to change the reference position based on a shift amount of an image plane obtained from the difference.
